(19) United States
(12) Patent Application Publication
(10) Pub. No.: US 2004/0157574 A1
(43) Pub. Date: Aug. 12, 2004

(54) Communications device

(76) Inventor: Ulrika Sallenhag, Lund (SE)

Correspondence Address: JENKENS & GILCHRIST, PC, 1445 ROSS AVENUE, SUITE 3200, DALLAS, TX, 75202, US

(21) Appl. No.: 10/480,987

(22) PCT Filed: Jun. 10, 2002
(86) PCT No.: PCT/EP02/06334

(30) Foreign Application Priority Data
Jun. 20, 2001 (GB) 0115088.7

(51) Int. Cl. H04B 17/00

(52) U.S. Cl. 455/226.1; 455/67.11

(57) ABSTRACT

In a radio transmitter, such as a mobile communications device, a filter is adjusted, based on a power level of a signal for transmission is detected, and/or on a mode of operation of the device. The bandwidth of the filter is adjusted, by controlling a transconductance element in the filter. The filter can therefore be controlled to have characteristics which are suitable for the operating conditions of the device in which the filter is being used, and which give an acceptable switching spectrum for the signals, while also allowing the output power of the power amplifier to ramp up acceptably quickly. For example, the filter can be adjusted depending on the communications standard (e.g. GSM or PCS) under which the device is operating, and depending on the power level of transmitted signals.

### TECHNICAL FIELD OF THE INVENTION

This invention relates to a communications device, and in particular to a radio communication device, such as a mobile phone.

More specifically, the invention relates to the adjustment of a filter within the transmit circuitry of the radio communication device, for use in different radio communication systems.

### BACKGROUND OF THE INVENTION

Different mobile radio communications service providers use different operating standards. In order to be able to use a phone in different areas, for example in different continents, it is necessary for the phone to be able to operate under those different standards.

The different operating standards place different requirements on the power amplifier and the filter circuitry in the transmit circuitry of the radio communication device.

EP-A-0682458 discloses a radio communication device, which is capable of operating in GSM and PCN modes. In a first mode, a power amplifier within a main unit of the device is set to produce output signals at power levels required by GSM, and a filter in the main unit is set so that it has a bandwidth required for GSM operation.

The device also includes an additional unit which contains an additional power amplifier. When this additional unit is connected to the main unit, the additional power amplifier is switched into the transmit signal path instead of the power amplifier within the main unit. The additional power amplifier is set to produce output signals at power levels required for PCN operation. Further, the filter in the main unit is adjusted so that it has a bandwidth required for PCN operation.

However, this arrangement has the disadvantage that the user needs to take specific action, namely connecting the additional unit to the main unit, in order to switch between GSM and PCN operation.

Further, although the prior art arrangement alters the filter bandwidth, depending on the mode of operation, it uses a single bandwidth within each mode.

### SUMMARY OF THE INVENTION

According to the present invention, a power level of a signal for transmission is detected, and the bandwidth of the filter is adjusted in response thereto.

In another preferred embodiment of the invention, a control signal which is used to control a mode of operation of an amplifier is detected, and the bandwidth of the filter is adjusted in response thereto.

In preferred embodiments of the invention, the filter is a transconductance filter. Further, when the filter is a transconductance filter, the bandwidth of the filter is advantageously adjusted by controlling a transconductance value within the filter.

It should be emphasised that the term “comprises/comprising” when used in this specification is taken to specify the presence of stated features, integers, steps or components but does not preclude the presence or addition of one or mores other features, integers, steps, components or groups thereof.

### BRIEF DESCRIPTION OF DRAWINGS

FIG. 1 is a block schematic diagram of a circuit in accordance with the invention.

FIG. 2 is a block schematic diagram of a second circuit in accordance with the invention.

FIG. 3 is a block schematic diagram of a third circuit in accordance with the invention.

### DETAILED DESCRIPTION OF PREFERRED EMEBODIMENTS

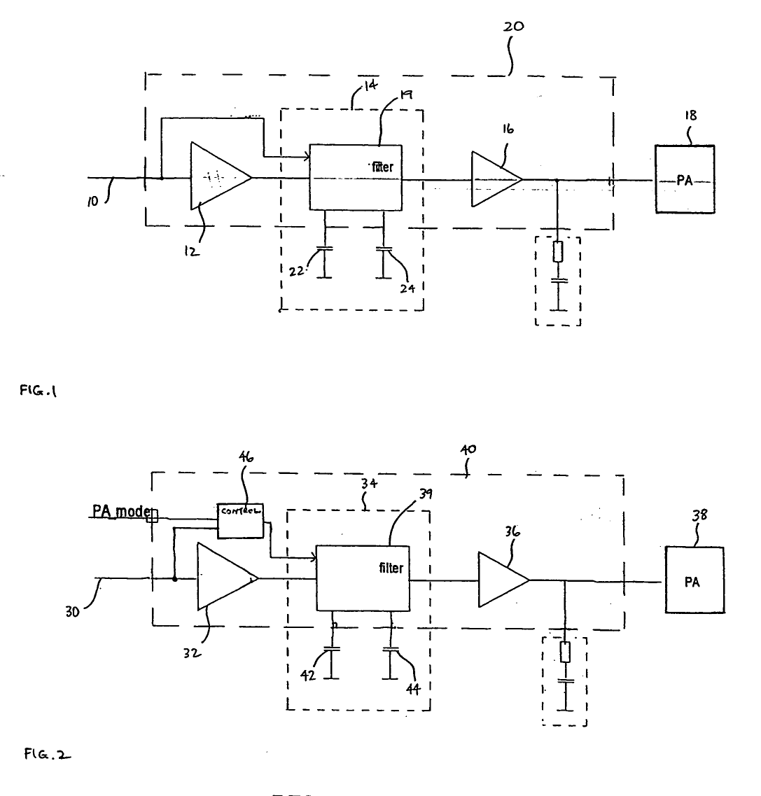

FIG. 1 is a block schematic diagram of the relevant components of a radio frequency transmitter. The invention is described herein with reference to its use in a mobile phone, but it will be appreciated that the invention is generally applicable to portable radio communication equipment or mobile radio terminals, such as mobile telephones, pagers, communicators, electronic organisers, smartphones, personal digital assistants (PDAs), or the like.

An input signal, which could for example be an analog signal or a digital code signal after analog-digital conversion, is provided on an input line 10. This signal is applied to an amplifier 12, which could for example be an exponential amplifier.

The output from the amplifier 12 is a step function, which needs to be smoothed in order to provide an output with an acceptable switch spectrum, that is, in order to remove the transient spurious signals that are caused by the switching of the power amplifier.

The smoothing function is provided by means of a filter 14, which in this presently preferred embodiment of the invention is a second-order transconductance filter.

The filtered output is supplied to a further amplifier 16, which acts as a buffer, and provides signals at the correct input level for a power amplifier 18, which provides the amplified signal for transmission over the air interface.

The amplifiers 12, 16 and an integrated part 19 of the filter 14 are provided on an integrated circuit 20. The properties of the filter 14, such as the cut off frequency and the slope of the frequency characteristic, are determined by the effective value of resistance in the integrated part 19 of the filter 14, and by the values of capacitors 22, 24, which are provided off the integrated circuit 20. The effective value of resistance in the integrated part 19 of the filter 14 is determined by the inverse of a transconductance value (gm).

The illustrated power amplifier block 18 preferably contains separate amplifier circuitry for each mode in which the device can operate. For example, a triple-band mobile phone which is operable under the GSM (i.e. GSM at 900 MHz), DCS (i.e. GSM at 1800 MHz) and PCS (i.e. GSM at 1900 MHz) standards preferably contains at least partially separate amplifier circuitry for use in those three modes.

As is conventional, the mobile phone will typically be required to transmit signals at a power level which depends on the distance of the mobile phone from its serving base station. The power level will typically be determined by the network, and a corresponding signal sent to the mobile phone. In a GSM (Global System for Mobile Communications) network, for example, there may be 19 available power levels, with the mobile phone being instructed to transmit at a selected one of those power levels.

Based on the received power level command, the input signal, which is provided on the input line 10, will vary in magnitude.

According to one aspect of the present invention, a connection is made between the input line 10 and the integrated part 19 of the filter 14. Based on the detected power level of the input signal, the value gm of the transconductance in the filter 14 is adjusted, so that the bandwidth, or cut-off frequency, of the filter takes a value which is appropriate for that power level.

This is required because the bandwidth, or cut-off frequency, of the filter affects the speed at which the power amplifier 18 can ramp up its output power to reach the required level. A higher cut-off frequency (that is, a wider bandwidth) allows faster ramping of the power amplifier output power. The filter properties must therefore be chosen so that the ramping of the power amplifier can be as required.

In the case of GSM, as mentioned above, there are 19 available power levels. However, it is probably sufficient to have 4 or 5 available transconductance values, which can be selected in response to the detected power level.

The filter characteristic must therefore be chosen to allow the filter to meet the demands on the switching spectrum and the time ramping properties of the power amplifier.

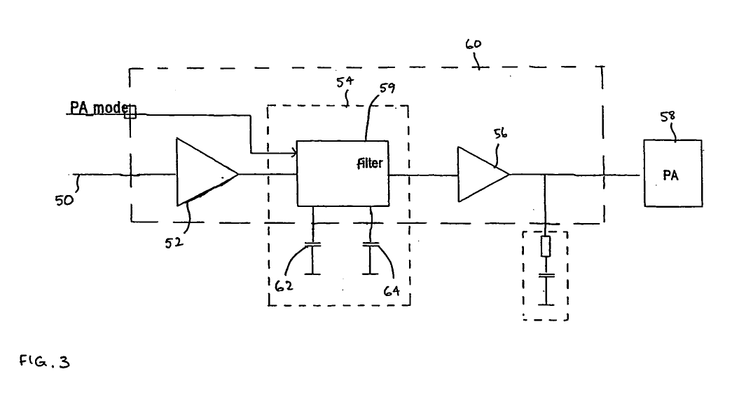

FIG. 2 is a block schematic diagram of the relevant components of an alternative radio frequency transmitter.

An input signal, which could for example be an analog signal or a digital code signal after analog-digital conversion, is provided on an input line 30. This signal is applied to an amplifier 32, which could for example be an exponential amplifier.

The output from the amplifier 32 is a step function, which needs to be smoothed in order to provide an output with an acceptable switch spectrum.

The smoothing function is provided by means of a filter 34, which in this presently preferred embodiment of the invention is a second-order transconductance filter.

The filtered output is supplied to a further amplifier 36, which acts as a buffer, and provides signals at the correct input level for a power amplifier 38, which provides the amplified signal for transmission over the air interface.

The amplifiers 32, 36 and an integrated part 39 of the filter 34 are provided on an integrated circuit 40.

The properties of the filter 34, such as the cut off frequency and the slope of the frequency characteristic, are determined by the effective value of resistance in the integrated part 39 of the filter 34, and by the values of capacitors 42, 44, which are provided off the integrated circuit 40. The effective value of resistance in the integrated part 39 of the filter 34 is determined by the inverse (1/gm) of a transconductance value (gm).

The illustrated power amplifier block 38 preferably contains separate amplifier circuitry for each mode in which the device can operate. For example, a triple-band mobile phone which is operable under the GSM, DCS and PCS standards preferably contains at least partially separate amplifier circuitry for use in those three modes.

As is conventional, the mobile phone will typically be required to transmit signals at a power level which depends on the distance of the mobile phone from its serving base station. The power level will typically be determined by the network, and a corresponding signal sent to the mobile phone. In a GSM (Global System for Mobile Communications) network, for example, there may be 19 available power levels, with the mobile phone being instructed to transmit at a selected one of those power levels.

Based on the received power level command, the input signal, which is provided on the input line 10, will vary in magnitude.

According to one aspect of the present invention, a connection is made between the input line 30 and a control block 46.

The control block also receives an input signal PA_mode, which indicates whether the phone is operating in GSM, DCS or PCS mode, and is the signal which is also used to control the power amplifier block 38, as 7 described above, so that the appropriate power amplifier circuitry is used.

Based on the detected power level of the input signal, and the mode of the power amplifier, the control block 46 determines an appropriate value for the transconductance in the integrated section 39 of the filter 34, and it sends a control signal to the filter so that the value gm of the transconductance in the filter takes the desired value.

The bandwidth, or cut-off frequency, of the filter 34 then takes a value which is appropriate for that mode and power level.

FIG. 3 is a block schematic diagram of the relevant components of a further alternative radio frequency transmitter.

An input signal, which could for example be an analog signal or a digital code signal after analog-digital conversion, is provided on an input line 50. This signal is applied to an amplifier 52, which could for example be an exponential amplifier.

The output from the amplifier 52 is a step function, which needs to be smoothed in order to provide an output with an acceptable switch spectrum.

The smoothing function is provided by means of a filter 54, which in this presently preferred embodiment of the invention is a second-order transconductance filter.

The filtered output is supplied to a further amplifier 56, which acts as a buffer, and provides signals at the correct input level for a power amplifier 58, which provides the amplified signal for transmission over the air interface.

The amplifiers 52, 56 and an integrated part 59 of the filter 54 are provided on an integrated circuit 60. The properties of the filter 54, such as the cut off frequency and the slope of the frequency characteristic, are determined by the effective value of resistance in the integrated part 59 of the filter 54, and by the values of capacitors 62, 64, which are provided off the integrated circuit 60. The effective value of resistance in the integrated part 59 of the filter 54 is determined by the inverse (1/gm) of a transconductance value (gm).

The illustrated power amplifier block 58 preferably contains separate amplifier circuitry for each mode in which the device can operate. For example, a triple-band mobile phone which is operable under the GSM, DCS and PCS standards preferably contains at least partially separate amplifier circuitry for use in those three modes.

According to one aspect of the present invention, an input signal PA_mode, which indicates whether the phone is operating in GSM, DCS or PCS mode, and is used to control the power amplifier block 58 so that the appropriate power amplifier circuitry is used, is also supplied to the integrated part 59 of the filter 58.

Based on the mode of the power amplifier, the transconductance device or devices in the integrated section 59 of the filter 54, are controlled so that the value gm of the transconductance in the filter takes the desired value.

The bandwidth, or cut-off frequency, of the filter 54 then takes a value which is appropriate for that mode and power level.

There are therefore described circuits which allow a transconductance filter to be controlled, so that the filter has characteristics which are suitable for the device in which the filter is being used.

1. A radio transmitter device, comprising power amplifier circuitry and a filter having adjustable filter characteristics for filtering input signals, comprising means for adjusting the filter characteristics based on a power level of the received signals.

2. A radio transmitter device as claimed in claim 1, wherein the power amplifier circuitry is operable in different operating modes, comprising means for adjusting the filter characteristics based on the power level of the input signals and on the operating mode of the power amplifier circuitry.

3. A radio transmitter device, comprising power amplifier circuitry which is operable in different operating modes, and a filter having adjustable filter characteristics for filtering input signals, comprising means for adjusting the filter characteristics based on the operating mode of the power amplifier circuitry.

4. A method of controlling a radio transmitter device, comprising power amplifier circuitry and a filter having adjustable filter characteristics for filtering input signals, comprising adjusting the filter characteristics based on a power level of the input signals.

5. A method of controlling a radio transmitter device as claimed in claim 4, wherein the power amplifier circuitry is operable in different operating modes, comprising adjusting the filter characteristics based on the power level of the input signals and on the operating mode of the power amplifier circuitry.

6. A method of controlling a radio transmitter device, comprising power amplifier circuitry which is operable in different operating modes, and a filter having adjustable filter characteristics for filtering input signals, comprising adjusting the filter characteristics based on the operating mode of the power amplifier circuitry.

7. A radio transmitter device, comprising:
an input for receiving signals for transmission;
a transconductance filter, comprising at least one transconductance element, for filtering the input signals; and
power amplifier circuitry, for amplifying the signals for transmission;
wherein the transconductance element is adjusted, in order to control a filter characteristic of the transconductance filter, based on a detected power level of the input signals.

8. A radio transmitter device as claimed in claim 7, wherein the or each transconductance element of the transconductance filter is provided on an integrated circuit, and the transconductance filter further comprises at least one capacitor which is not provided on the integrated circuit.

9. A mobile communications device, for use in a mobile communications network, wherein the power level of transmitted signals is controlled by a power level signal sent from the network to the mobile communications device, wherein the mobile communications device comprises a radio transmitter device as claimed in claim 7.

10. A radio transmitter device as claimed in claim 7, wherein the power amplifier circuitry is adjustable, based on a mode of operation of the device, wherein the transconductance element is adjusted based on a detected power level of the input signals and on the mode of operation of the device.

11. A mobile communications device, for use in a mobile communications network operating under a selected one of a plurality of operating standards, wherein the power amplifier circuitry is adjustable, based on the selected operating standard, and wherein the transconductance element is adjusted based on a detected power level of the input signals and on the selected operating standard.

12. A mobile communications device as claimed in claim 11, wherein the device is for use in at least networks operating under GSM and PCS standards.

13. A radio transmitter device, comprising:
an input for receiving signals for transmission;
a transconductance filter, comprising at least one transconductance element, for filtering the input signals; and
power amplifier circuitry, for amplifying the signals for transmission, wherein the power amplifier circuitry is adjustable, based on a mode of operation of the device;
wherein the transconductance element is adjusted, in order to control a filter characteristic of the transconductance filter, based on a detected mode of operation of the device.

14. A mobile communications device, for use in a mobile communications network operating under a selected one of a plurality of operating standards, wherein the power amplifier circuitry is adjustable, based on the selected operating standard, and wherein the transconductance element is adjusted based on the selected operating standard.

15. A mobile communications device as claimed in claim 14, wherein the device is for use in at least networks operating under GSM and PCS standards.
